(19) United States
(12) Patent Application Publication
(10) Pub. No.: US 2024/0215783 A1
(43) Pub. Date: Jul. 4, 2024

(54) FAN ASSEMBLY, DUST COLLECTION PILE, AND CLEANING SYSTEM

(71) Applicant: Beijing Roborock Technology Co., Ltd., Beijing (CN)

(72) Inventor: Chengyang WANG, Beijing (CN)

(21) Appl. No.: 18/557,097

(22) PCT Filed: Oct. 21, 2021
(86) PCT No.: PCT/CN2021/125376

§ 371 Date: Oct. 25, 2023

(30) Foreign Application Priority Data
Apr. 25, 2021 (CN) 202110463702.3

(51) Int. Cl. A47L 9/22; A47L 9/00; A47L 9/10

(52) U.S. Cl. CPC A47L 9/22; A47L 9/0081; A47L 9/106

(57) ABSTRACT

A fan assembly is described, including a housing, a fan, and a flexible member located between two ends of the fan and the housing. The fan is fixed within the housing by the flexible member, and the flexible member is configured to avoid a direct contact between the fan and the housing.

### CROSS-REFERENCE TO RELATED APPLICATIONS

The present application is a national phase application under 35 U.S.C. § 371 of International Application No. PCT/CN21/125376 filed Oct. 21, 2021, which claims the benefit of and priority to Chinese Patent Application No. 202110463702.3, filed on Apr. 25, 2021, both of which are incorporated by reference in their entireties herein as a part of the present application.

### TECHNICAL FIELD

The present disclosure relates to the field of intelligent home technologies and, more particularly, to a fan assembly, a dust collection pile, and a cleaning system.

### BACKGROUND

In the field of intelligent cleaning, a fan assembly is the most commonly used power component. In the related art, the fan assembly includes a housing and fans provided inside the housing, where the fans are all fixed inside the housing directly. Therefore, the fans and the housing must be of a structure adapted to each other, and it is prone to causing large noise.

### BRIEF SUMMARY

The present disclosure provides a fan assembly, a dust collection pile, and a cleaning system, which are used for improving the usage performance of the fan assembly.

According to a first aspect of the present disclosure, there is provided a fan assembly. The fan assembly includes:
a housing;
a fan; and
a flexible member, located between the housing and two ends of the fan, the fan being fixed within the housing by the flexible member, and the flexible member avoiding a direct contact between the fan and the housing.

In some embodiments of the present disclosure, the housing includes:
a first housing member; and
a second housing member, detachably connected to the first housing member to release or fix the fan and the flexible member.

In some embodiments of the present disclosure, the flexible member includes:
a first flexible portion, provided between the fan and the first housing member to support the fan; and
a second flexible portion, at least a part of the second flexible portion being provided between the fan and the second housing member to clamp the fan together with the first flexible portion.

In some embodiments of the present disclosure, the first flexible portion is provided independently from the second flexible portion.

In some embodiments of the present disclosure, a part of the second flexible portion is clamped between first housing member and the second housing member to seal a gap between the first housing member and the second housing member.

In some embodiments of the present disclosure, the first flexible portion is a rubber pad, and the second flexible portion is a rubber sleeve.

In some embodiments of the present disclosure, the second housing member is provided with an airflow through hole, where the airflow through hole is communicated with an air inlet of the fan, and there is a clearance between the first housing member and the fan, and
where, an air discharging channel is formed among the first flexible portion, the second flexible portion, the first housing member, and the fan; and, the air discharging channel is communicated with an air outlet of the fan.

In some embodiments of the present disclosure, the fan assembly further includes an air discharging hole, where the air discharging hole is communicated with the air discharging channel.

In some embodiments of the present disclosure, the fan assembly further includes:
a silencer, provided on the housing, an inlet of the silencer being communicated with the air discharging hole, or an outlet of the silencer being communicated with the air discharging hole.

In some embodiments of the present disclosure, the air discharging channel is provided around a circumferential outer surface of the fan, and a length of the air discharging channel extending along the circumferential outer surface of the fan is greater than a length of the air discharging hole extending along the circumferential outer surface of the fan.

According to a second aspect of the present disclosure, there is provided a dust collection pile. The dust collection pile includes:
a body, including a dust inlet channel, the dust inlet channel having a dust inlet connected to a dust box;
a dust barrel, detachably provided on the body, a dust inlet end of the dust barrel being communicated with the dust inlet channel to collect dust entering through the dust inlet channel; and
a fan assembly, provided on the body, an air inlet of the fan assembly being communicated with an airflow outlet end of the dust barrel, and the fan assembly running and generating a negative pressure, such that the dust within the dust box is able to enter the dust inlet channel through the dust inlet and an airflow is enabled to circulate; where,
the fan assembly includes:
a housing;
a fan; and
a flexible member, located between the housing and two ends of the fan, the fan being fixed within the housing by the flexible member, and the flexible member avoiding a direct contact between the fan and the housing.

In some embodiments of the present disclosure, the flexible member includes:
a first flexible portion, provided between the fan and the first housing member to support the fan; and
a second flexible portion, at least a part of the second flexible portion being provided between the fan and the second housing member to clamp the fan together with the first flexible portion.

In some embodiments of the present disclosure, the first flexible portion is provided independently from the second flexible portion.

In some embodiments of the present disclosure, a part of the second flexible portion is clamped between the first housing member and the second housing member to seal a gap between the first housing member and the second housing member.

In some embodiments of the present disclosure, the first flexible portion is a rubber pad, and the second flexible portion is a rubber sleeve.

In some embodiments of the present disclosure, the second housing member is provided with an airflow through hole, where the airflow through hole is communicated with an air inlet of the fan, and there is a clearance between the first housing member and the fan, and
where, an air discharging channel is formed among the first flexible portion, the second flexible portion, the first housing member, and the fan; and, the air discharging channel is communicated with an air outlet of the fan.

In some embodiments of the present disclosure, the fan assembly further includes an air discharging hole, where the air discharging hole is communicated with the air discharging channel.

In some embodiments of the present disclosure, the fan assembly further includes:
a silencer, provided on the housing, an inlet of the silencer being communicated with the air discharging hole, or an outlet of the silencer being communicated with the air discharging hole.

In some embodiments of the present disclosure, the discharging channel is provided around a circumferential outer surface of the fan, and a length of the air discharging channel extending along the circumferential outer surface of the fan is greater than a length of the air discharging hole extending along the circumferential outer surface of the fan.

According to a third aspect of the present disclosure, a cleaning system is provided. The cleaning system includes the above-mentioned dust collection pile and a cleaning robot.

According to the fan assembly in the embodiments, by locating the flexible member between the housing and the fan, a hard contact between the housing and the fan is avoided, thereby avoiding producing large noise. In addition, since the housing and the fan are not connected directly, the shape and the size of the flexible member may be adjusted according to usage requirements, so that the fans of different sizes are mounted within the housing, so as to improve the generality of the housing and further promote the generality of the overall dust collection pile, thereby avoiding the need to adjust an internal structure of the dust collection pile as a whole due to a change in size or model of the fans.

### BRIEF DESCRIPTION OF THE DRAWINGS

Various objects, features, and advantages of the present disclosure will become more apparent by considering the following detailed description of the various embodiments of the present disclosure in conjunction with the accompanying drawings. The accompanying drawings are merely exemplary illustration of the present disclosure, and are not necessarily drawn to scale. In the accompanying drawings, same reference signs indicate the same or similar components throughout. In the accompanying drawings:

FIG. 1 is a schematic structural diagram of a cleaning system shown according to some embodiments;

FIG. 2 is a schematic structural diagram of a dust collection pile shown according to some embodiments from a first view angle;

FIG. 3 is a schematic structural diagram of a dust collection pile shown according to some embodiments from a second view angle;

FIG. 4 is a schematic structural diagram of a dust collection pile shown according to some embodiments from a third view angle;

FIG. 5 is a schematic diagram of a disassembled structure of a dust collection pile shown according to some embodiments;

FIG. 6 is a schematic diagram of another disassembled structure of a dust collection pile shown according to some embodiments;

FIG. 7 is a schematic diagram of a sectional structure of a dust collection pile shown according to some embodiments;

FIG. 8 is a schematic diagram of part of a sectional structure of a dust collection pile shown according to some embodiments;

FIG. 9 is a schematic diagram of part of a sectional structure of a dust collection pile shown according to some other embodiments;

FIG. 10 is a schematic structural diagram of a mounting body of a dust collection pile shown according to some embodiments;

FIG. 11 is a schematic diagram of a disassembled structure of a dust bag transition device of a dust collection pile shown according to some embodiments;

FIG. 12 is a schematic structural diagram of a contact detection element of a dust collection pile in a state shown according to some embodiments;

FIG. 13 is a schematic structural diagram of a contact detection element of a dust collection pile in another state shown according to some embodiments;

FIG. 14 is a schematic structural diagram of a first filtering assembly of a dust collection pile shown according to some embodiments;

FIG. 15 is a schematic diagram of a disassembled structure of a first filtering assembly of a dust collection pile shown according to some embodiments;

FIG. 16 is a schematic diagram of a disassembled structure of a fan assembly of a dust collection pile shown according to some embodiments;

FIG. 17 is a schematic diagram of a sectional structure of a fan assembly of a dust collection pile shown according to some embodiments;

FIG. 18 is a schematic structural diagram of a first housing member of a fan assembly of a dust collection pile shown according to some embodiments;

FIG. 19 is a schematic structural diagram of a second filtering assembly of a dust collection pile shown according to some embodiments from a first view angle;

FIG. 20 is a schematic structural diagram of a second filtering assembly of a dust collection pile shown according to some embodiments from a second view angle;

FIG. 21 is a schematic structural diagram of a second filtering assembly of a dust collection pile shown according to some embodiments from a third view angle;

FIG. 22 is a schematic structural diagram of a second filtering assembly of a dust collection pile shown according to some embodiments from a fourth view angle;

FIG. 23 is a schematic diagram of a disassembled structure of a base of a dust collection pile shown according to some embodiments;

FIG. 24 is a schematic diagram of a separated structure of a shielding member and a sealing groove of a dust collection pile shown according to some embodiments;

FIG. 25 is a schematic structural diagram of a second filtering assembly and a spoiler of a dust collection pile shown according to some embodiments from a first view angle;

FIG. 26 is a schematic structural diagram of a second filtering assembly and a spoiler of a dust collection pile shown according to some embodiments from a second view angle;

FIG. 27 is a schematic structural diagram of a second filtering assembly and a spoiler of a dust collection pile shown according to some embodiments from a third view angle; and

FIG. 28 is a schematic structural diagram of a second filtering assembly and a spoiler of a dust collection pile shown according to some other embodiments.

### REFERENCE NUMERALS REPRESENT THE FOLLOWING COMPONENTS

1. cleaning robot; 2. dust collection pile;
10. body; 101. base; 102. mounting body; 103. first charging contact tab; 11. dust inlet channel; 111. dust inlet; 12. liquid outlet hole; 13. first mounting portion; 131. switch; 132. detection button; 133. elastic member; 14. second mounting portion; 15. first channel; 16. mounting groove; 17. communication pipeline; 18. second channel; 19. sealing groove;
20. dust barrel; 21. dust inlet end; 22. airflow outlet end; 23. dust bag; 231. transition portion; 24. cyclone separator; 25. dust bag transition device;
30. first filtering assembly; 31. air inlet end; 32. air outlet end; 33. dust containing member; 34. filtering portion; 35. top cover; 351. air inlet channel;
40. fan assembly; 41. air inlet; 42. air outlet; 43. housing; 431. first housing member; 4311. space; 4312. vent hole; 432. second housing member; 433. airflow through hole; 434. air discharging hole; 44. fan; 45. flexible member; 451. first flexible portion; 452. second flexible portion; 46. air discharging channel; 47. silencer;
50. second filtering assembly; 51. air collection port; 52. air outlet surface; 53. opening; 54. frame; 541. frame body; 542. sealing member; 543. first support; 544. second support; 545. first connecting section; 546. second connecting section; 55. filter screen; 56. evasion groove; 561. first opening; 562. second opening; 563. third opening;
60. spoiler; 61. spoiler channel; 62. air outlet channel; 63. first surface; 64. second surface; 65. communication channel;
70. air outlet plate; 71. through hole; 80. air inlet conduit; 90. shielding member.

### DETAILED DESCRIPTION

The technical solutions in exemplary embodiments of the present disclosure will be described clearly and completely in combination with accompanying drawings in the exemplary embodiments of the present disclosure hereinafter. The exemplary embodiments described herein are merely for the purpose of illustration, and are not intended to limit the protection scope of the present disclosure. Therefore, it should be understood that various modifications and changes can be made to the exemplary embodiments without departing from the protection scope of the present disclosure.

In the description of the present disclosure, unless otherwise explicitly specified and defined, the terms “first” and “second” are merely for the purpose of description, and cannot be construed as indicating or implying relative importance; the term “a plurality of” refers to two or more; and the phrase “and/or” includes any or all combinations of one or more associated listed items. Particularly, references to “the/said” object or “an” object are also intended to represent one of a plurality of such possible objects.

Unless otherwise specified or illustrated, the terms such as “connection” and “fixation” should be understood in a broad sense. For example, the term “connection” may be fixed connection, or detachable connection or integrated connection; or may be electric connection or signal connection; or may be direct connection; or indirect connection via an intermediation. The specific meanings of the above terms in the present disclosure may be understood according to specific circumstances for those skilled in the art.

Furthermore, in the description of the present disclosure, it should be understood that orientation words described in the exemplary embodiments of the present disclosure, such as “upper”, “lower”, “inner”, and “outer” are described from view angles as shown in the drawings, and should not be construed as a limitation to the exemplary embodiments of the present disclosure. It should also be understood that in the context, when an element or feature is mentioned as being connected “onto”, “under”, “inside” or “outside” other elements (one or more), the element may be not only directly connected “onto”, “under”, “inside” or “outside” other elements (one or more), but also indirectly connected “onto”, “under”, “inside” or “outside” other elements (one or more) via an intermediate element.

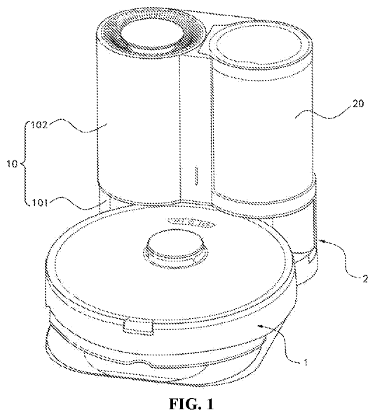

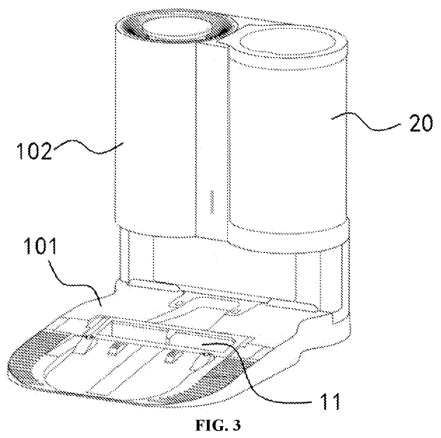

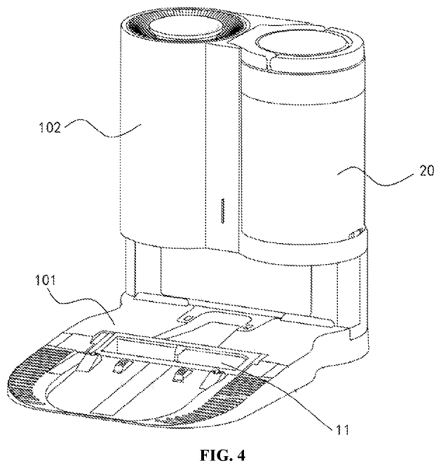

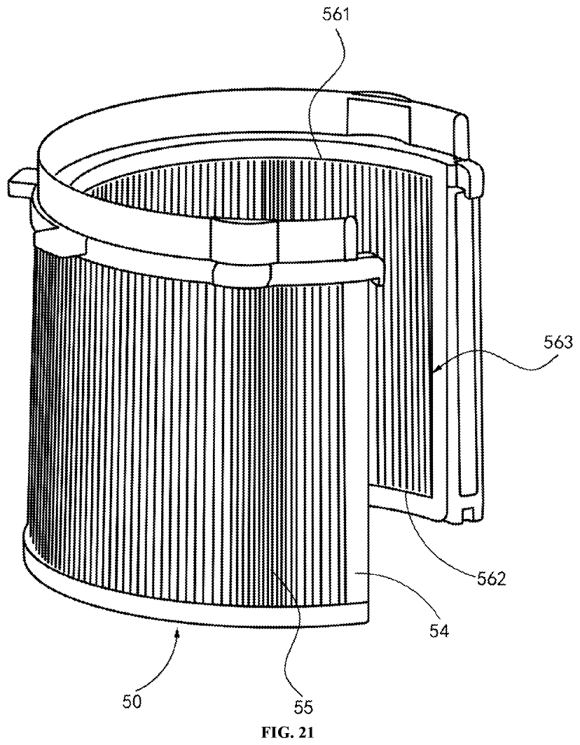

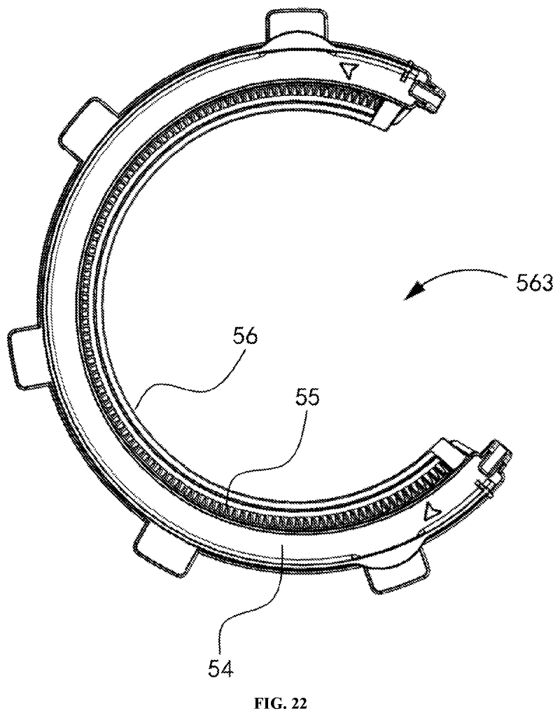

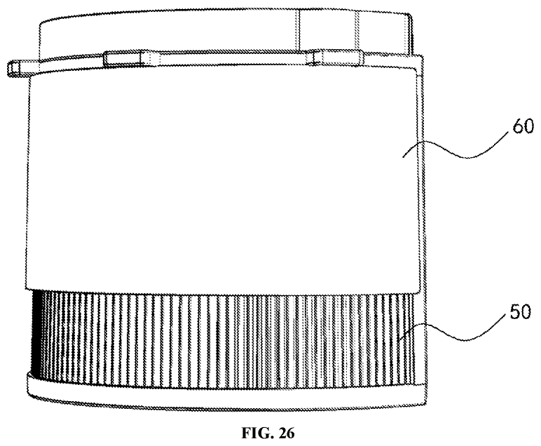

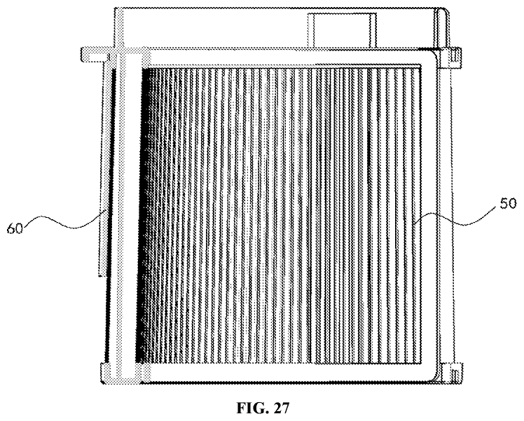

As shown in FIGS. 1-28, a cleaning system in the embodiments of the present disclosure includes a dust collection pile 2 and a cleaning robot 1.

In the technical solutions provided in the embodiments of the present disclosure, the cleaning robot includes a robot body. The robot body may have an approximately circular shape, or may also have other shapes, including but not limited to an approximate D-shaped shape for which the front is square and the rear is circular.

The cleaning robot may further include a cleaning system, a perception system, a control system, a driving system, an energy system, and a human-computer interaction system, etc. The various systems coordinate and cooperate with each other to enable the cleaning robot to move autonomously, thereby achieving a cleaning function. Functional elements and the like that constitute the various systems described above in the cleaning robot may be integrated within the cleaning robot body. The cleaning robot body may include an upper closing cover, a chassis, and a middle frame provided between the upper closing cover and the chassis. The middle frame may be used as a basic framework for disposing various functional elements. The upper closing cover and the chassis cover the surface of a device body, function to protect internal parts and components, and may improve the aesthetics of the cleaning robot.

The perception system is used for the cleaning robot to perceive an external environment such as terrain and a posture of the cleaning robot itself, and may provide various position information and motion state information about the robot to the control system of the cleaning robot.

In the technical solutions provided in the embodiments of the present disclosure, the perception system may include a position determining device including but not limited to an infrared transmitting and receiving device, a camera, and a laser distance sensor (LDS). The position determining device may be provided at the top or on the side of the cleaning robot. In the movement process of the cleaning robot, the position determining device obtain a current position of the cleaning robot by determining a distance between the cleaning robot and a surrounding obstacle.

A buffer is used to buffer a collision between the robot body and a surrounding object during movement. A layer of soft rubber is provided on the surface of the buffer, and the buffer is spaced from the device body by a predetermined distance when mounted to the device body, so as to ensure that the device body can have enough time to decelerate in case of collision.

The control system is provided on a circuit main board within the robot body. It may be understood that the circuit main board is provided with various control circuits that control the running of the cleaning robot. The control system includes a NAND transitory memory, a computing processor, etc. The computing processor may be a central processing unit, an application processor, etc., and draws a real-time map of an environment where the cleaning robot is located by using a positioning algorithm according to obstacle information fed back by the laser distance sensor. In addition, in combination with distance information and speed information fed back by the buffer and a sensing device, a current operating state of the cleaning robot is comprehensively determined, such as crossing a doorsill, getting on a carpet, locating at a cliff, being stuck from above or below, having a full dust box, being picked up, etc., and a specific next action strategy may also be given for different situations, so that the work of the cleaning robot better meets requirements, thereby improving the user experience.

The human-computer interaction system may include a button on a host panel for a user to select functions; it may further include a display screen and/or an indicator and/or a speaker for showing a current state of the robot or function selection options to the user; and, it may further include a mobile phone client application. The cleaning robot may show a map of the environment where the robot is located, the position where the cleaning robot is located, and the state information about the cleaning robot, etc., to the user through the mobile phone client application.

The energy system is used to provide electrical energy for the work of the functional elements of the various systems, and mainly includes a charging battery and a power supply circuit. The charging battery may be a nickel-metal hydride battery and a lithium battery. When an electric quantity in the charging battery is lower than a predetermined minimum electric quantity, it may be charged by connecting a charging electrode provided on the side of or below the device body with a charging device.

In addition, the cleaning robot further includes a cleaning mechanism, which is provided on the robot body. The cleaning mechanism removes debris from a surface to be cleaned by interfering with the surface to be cleaned.

The cleaning mechanism includes a wet cleaning portion and a dry cleaning portion. The wet cleaning portion may be a flat mop, which is connected onto the robot body.

The dry cleaning portion may be a ground-sweeping rolling brush, and sucks impurities on the ground into the dust box through a negative pressure generated by a fan with the cooperation of the ground-sweeping rolling brush, the dust box, the fan, and the like. That is, the impurities on the ground enter the dust box through a garbage inlet of the robot body.

In the technical solutions provided in the embodiments of the present disclosure, the dust collection pile includes a body 10, a dust barrel 20, and a fan assembly 40.

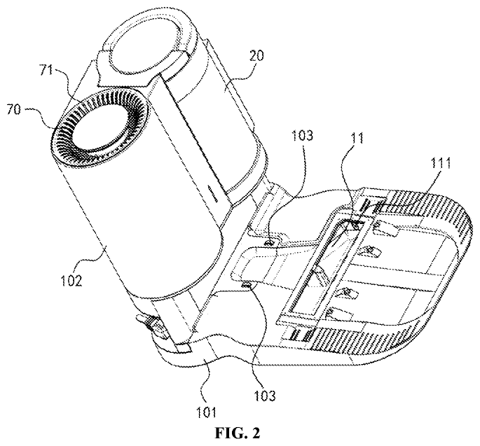

As shown in FIGS. 2-6, the body 10 includes a dust inlet channel 11, where the dust inlet channel 11 has a dust inlet 111, and the dust inlet 111 is used to be communicated with the dust box, so that dust within the dust box can enter the dust inlet channel 11 through the dust inlet 111.

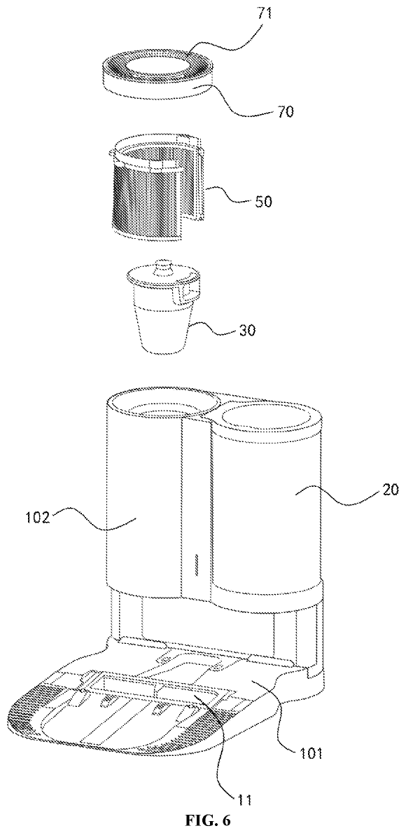

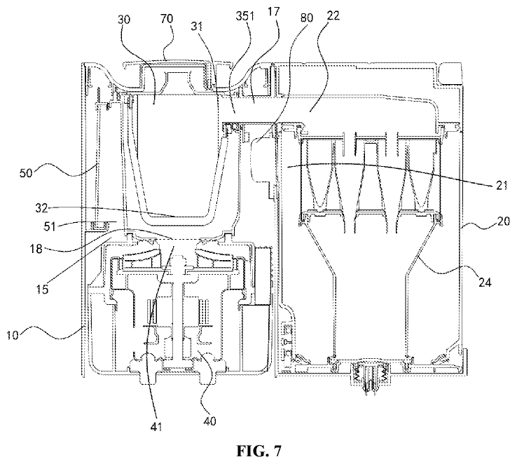

As shown in conjunction with FIGS. 6 and 7, the dust barrel 20 is detachably provided on the body 10, and a dust inlet end 21 of the dust barrel 20 is communicated with the dust inlet channel 11, so as to collect the dust entering from the dust inlet channel 11.

The fan assembly 40 is provided on the body 10, an air inlet 41 of the fan assembly 40 is communicated with an airflow outlet end 22 of the dust barrel 20, and the fan assembly 40 generates a negative pressure, so as to ensure that the dust within the dust box can enter the dust inlet channel 11 through the dust inlet 111 and enable an airflow to circulate. Here, the dust within the dust box includes the debris within the dust box.

In some embodiments, when the cleaning robot moves to the body 10, and a garbage inlet of the cleaning robot is communicated with the dust inlet 111 of the dust inlet channel 11, the fan assembly 40 runs at this point, so that a seal is formed between the garbage inlet of the cleaning robot and the dust inlet 111 of the dust inlet channel 11, so as to suck the dust within the dust box into the dust inlet channel 11.

After the cleaning robot moves in position, the dust collection pile in the embodiments can suck the dust within the dust box into the dust barrel 20 for collection through the running of the fan assembly 40, and finally, the airflow is discharged through the fan assembly 40, such that the dust within the dust box of the cleaning robot is recycled into the dust barrel 20. Therefore, automated processing may be enabled during the whole dust cleaning process.

It should be noted that the dust barrel 20 is detachably provided on the body 10, so as to facilitate cleaning and replacing of the dust barrel 20.

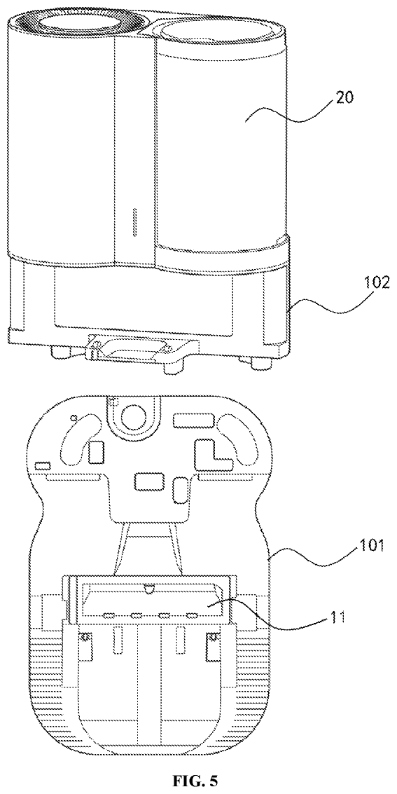

In some embodiments, as shown in FIGS. 5 and 6, the body 10 includes a base 101 and a mounting body 102. The dust inlet channel 11 is formed within the base 101, the dust inlet 111 is provided at the top of the base 101, and the cleaning robot moves to the base 101 to clean the dust.

The mounting body 102 is connected to the base 101, and an air inlet conduit 80 is provided within the mounting body 102. As shown in FIG. 7, the air inlet conduit 80 communicates the dust inlet channel 11 with the dust inlet end 21, so that the dust enters the dust barrel 20 from the dust inlet channel 11 through the air inlet conduit 80.

In some embodiments, the dust barrel 20 is detachably provided on the mounting body 102. The fan assembly 40 is provided on the mounting body 102.

The cleaning robot enters the base 101 from a front end of the base 101, and the mounting body 102 is provided at a rear end of the base 101, so that the cleaning robot may not collide with the mounting body 102 during movement.

In some embodiments, the mounting body 102 and the base 101 may be of an integrated structure. Here, the integrated structure may be integrally formed, and may also refer to connecting and fixing two separate components to form an integral structure.

In some embodiments, the mounting body 102 is detachably connected to the base 101. That is, the mounting body 102 may be separated from the base 101 before use, so as to facilitate transportation and storage, etc., and the mounting body 102 may be connected to the base 101 during use by means of a connection manner in the related art such as a fastener or snap-fitting.

In some embodiments, the air inlet conduit 80 may be connected onto the base 101, that is, the air inlet conduit 80 is connected onto the base 101 after the mounting body 102 is separated from the base 101. In some embodiments, the air inlet conduit 80 may be connected onto the mounting body 102, that is, the air inlet conduit 80 is connected onto the mounting body 102 after the mounting body 102 is separated from the base 101. In some embodiments, the air inlet conduit 80 may be enabled to be separated from the base 101 and the mounting body 102. In some embodiments, it is not excluded that the air inlet conduit 80 is integrated onto the base 101 or the mounting body 102.

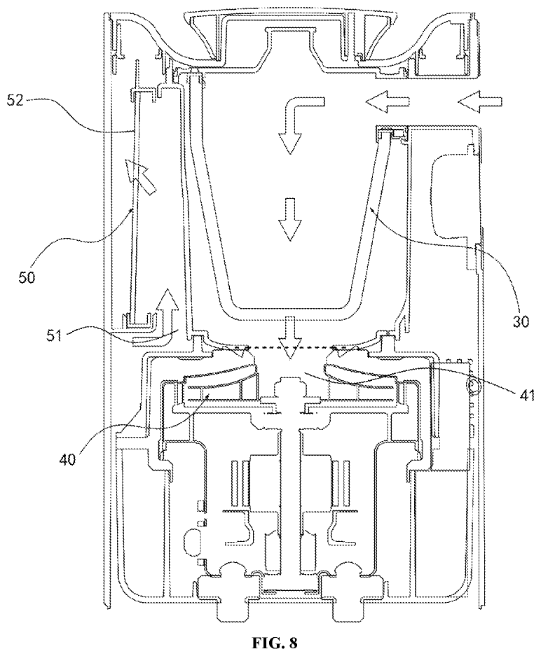

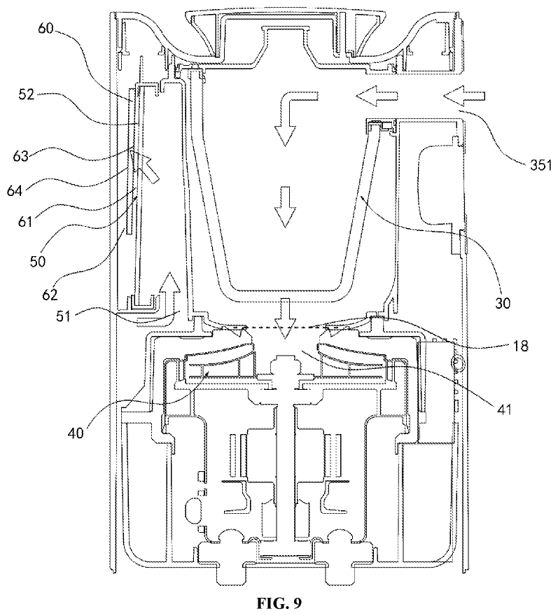

In some embodiments, as shown in FIGS. 8 and 9, the dust collection pile further includes the first filtering assembly 30. The first filtering assembly 30 is provided above the fan assembly 40.

An air inlet end 31 of the first filtering assembly 30 is communicated with the airflow outlet end 22 of the dust barrel 20, so as to filter the airflow discharged through the dust barrel 20.

An air outlet end 32 of the first filtering assembly 30 is communicated with the air inlet 41 of the fan assembly 40. When the cleaning robot moves to the body 10 and the garbage inlet of the cleaning robot is communicated with the dust inlet 111 of the dust inlet channel 11, the fan assembly 40 runs and generates the negative pressure at this point, which can suck the dust within the dust box into the dust barrel 20 for collection, and the airflow is filtered through the first filtering assembly 30 prior to entering the fan assembly 40, thereby avoiding the dust from entering the interior of the fan assembly 40. Finally, the airflow is discharged from the fan assembly 40, such that the dust within the dust box of the cleaning robot is recycled into the dust barrel 20. Therefore, automated processing may be enabled during the whole dust cleaning process.

The first filtering assembly 30 is located above the fan assembly 40. That is, the airflow discharged from the dust barrel 20 need to be filtered through the first filtering assembly 30 firstly, and then flows into the air inlet 41 of the fan assembly 40 from the bottom of the first filtering assembly 30, so that the distribution of flowing paths of the airflow is more reasonable, and it can be ensured that the distribution of the components is more reasonable, thereby utilizing the height space effectively.

The first filtering assembly 30 may be directly provided on the body 10, or directly provided on the fan assembly 40.

In some embodiments, the first filtering assembly 30 is provided on the mounting body 102. That is, after the mounting body 102 is separated from the base 101, the dust barrel 20, the first filtering assembly 30, and the fan assembly 40 may be all separated from the base 101 along with the mounting body 102.

In some embodiments, the first filtering assembly 30 is detachably provided on the mounting body 102, or may also be fixed onto the mounting body 102.

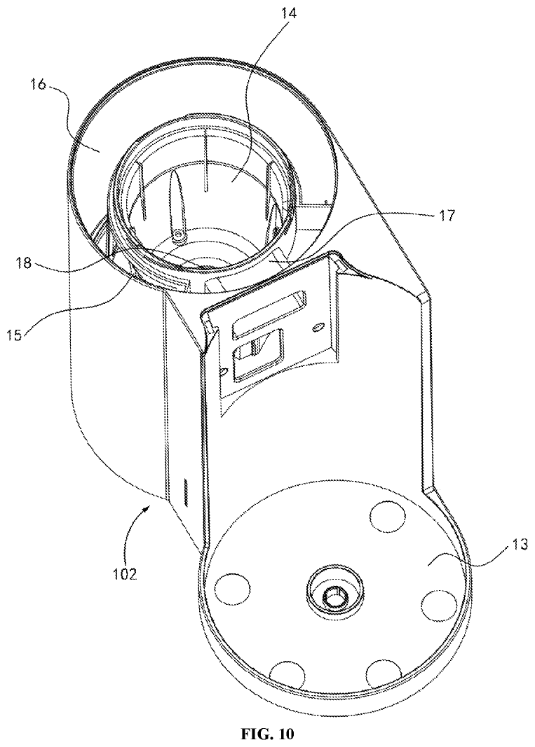

In some embodiments, as shown in FIG. 10, the body 10 further includes a first mounting portion 13 and a second mounting portion 14. The first mounting portion 13 and the second mounting portion 14 are respectively used to mount the dust barrel 20 and the first filtering assembly 30. Among them, the first mounting portion 13 and the second mounting portion 14 are provided on the mounting body 102.

A first detection member is provided between the dust barrel 20 and the first mounting portion 13 and used for detecting whether the dust barrel 20 and the first mounting portion 13 are mounted in position. For example, when the dust barrel 20 and the first mounting portion 13 are mounted in position, the first detection member may send a first signal.

A second detection member is provided between the first filtering assembly 30 and the second mounting portion 14 and used for detecting whether the first filtering assembly 30 and the second mounting portion 14 are mounted in position. For example, when the first filtering assembly 30 and the second mounting portion 14 are mounted in position, the second detection member may send a second signal.

The dust collection pile further includes a control portion that is in signal connection with the first detection member or the second detection member. The control portion is in signal connection with the fan assembly 40, and the first detection member is in signal connection with the second detection member, so that the control portion cannot start the fan assembly 40 when at least one of the dust barrel 20 and the first filtering assembly 30 is not mounted in position. That is, the first detection member and the second detection member are in a series connection relationship. Therefore, the control portion can start the fan assembly 40 only when the first detection member sends the first signal and the second detection member sends the second signal. For example, the first detection member may be connected to a control end of the second detection member, while a signal transmitting end of the second detection member is connected to the control portion. If the control end of the second detection member cannot receive the first signal sent by the first detection member, the second detection member cannot send a starting signal (for example, the second signal) to the control portion either even if the first filtering assembly 30 and the second mounting portion 14 are mounted in position.

In the embodiments, relationship between in-position detection of the dust barrel 20 and in-position detection of the first filtering assembly 30 can be implemented by connecting the first detection member with the second detection member in series. That is, even if the dust barrel 20 is not in position, or the first filtering assembly 30 is not in position, or both of them are not in position, the control portion may recognize them as being not in position (that is, the control portion determines that the dust collection pile is not mounted in position), so that electrical connection components and recognition components may be reduced.

In some embodiments, the dust barrel 20 is detachably connected to the first mounting portion 13, so as to facilitate the cleaning and replacing of the dust barrel 20.

It should be noted that the dust barrel 20 and the first mounting portion 13 may be in snap-fitting, for example, fitting between a bump and a slide way; or, a mounting groove may be formed in the first mounting portion 13, while at least a part of the dust barrel 20 is located within the mounting groove, which is not defined here and may be selected according to actual needs as long as it is ensured that they are easy to mount and will not fall off arbitrarily.

In some embodiments, the first filtering assembly 30 is detachably connected to the second mounting portion 14, so as to facilitate the cleaning and replacing of the first filtering assembly 30, thereby improving the filtering capability of the first filtering assembly 30.

It should be noted that the first filtering assembly 30 and the second mounting portion 14 may be in snap-fitting, for example, fitting between a bump and a slide way; or, a mounting groove may be formed in the second mounting portion 14, while at least a part of the first filtering assembly 30 is located within the mounting groove, which is not defined here and may be selected according to actual needs as long as it is ensured that they are easy to mount and will not fall off arbitrarily. In the embodiments, the second mounting portion 14 has a mounting cavity, and the first filtering assembly 30 is located within the mounting cavity. In addition, a sealed connection is formed between the upper portion of the first filtering assembly 30 and the body 10. A second channel 18 is provided on the body 10, and the second channel 18 communicates the air outlet end 32 of the first filtering assembly 30 with the air inlet 41 of the fan assembly 40, so as to ensure that the airflow discharged from the first filtering assembly 30 only enters the air inlet 41 of the fan assembly 40 through the second channel 18.

In some embodiments, the dust barrel 20 includes a dust bag 23 or the cyclone separator 24. The dust barrel 20 may collect garbage through the dust bag 23 or through the cyclone separator 24. Among them, the dust bag may be a paper bag or cloth bag with good air permeable and dust proof effects, as long as it is easy to replace.

It should be noted that the cyclone separator 24 may be a cyclone separator known in the related art. The working principle of the cyclone separator is as follows: when particles are used to perform a high-speed rotation in the airflow with the help of a rotary motion caused by tangential introduction of the airflow, a centrifugal force is much greater than the gravity; since the greater the speed is, the greater the centrifugal settling speed obtained by the particles is, when the particles containing solid particles enter a cone-shaped cylinder in a tangential direction with air and rotate in the cylinder, the airflow collides with a wall of the cyclone separator, and the particles hit a wall of a tube and descend in a rotary manner, thereby achieving the purpose of separation between the solid and the air. In the embodiments, the air finally enters the air inlet end 31 of the first filtering assembly 30 through the airflow outlet end 22 of the dust barrel 20.

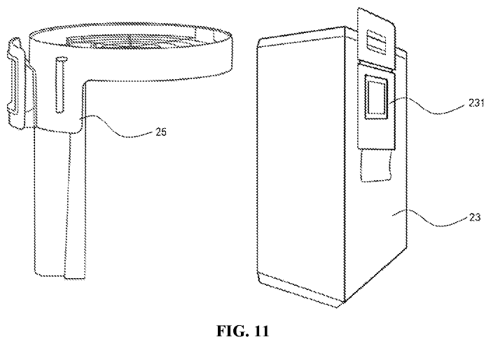

In some embodiments, the dust barrel 20 mounted with the cyclone separator 24 may be mounted with the dust bag 23 through a dust bag transition device 25 to meet different requirements of the user. That is, the dust bag transition device 25 is similar to a support and mainly used to mount the dust bag 23 onto the dust barrel 20 and has a specific structure similar to a component of the cyclone separator 24 that is used to be connected with the dust barrel 20, which is not defined here as long as it can be connected to the dust barrel 20. Actually, it is similar to a component provided by imitating a connection structure of the cyclone separator 24. In some embodiments, the dust bag 23 may be provided with a transition portion 231 used to be connected with the dust bag transition device 25, which is specifically as shown in FIG. 11.

In some embodiments, the first mounting portion 13 is selectively mounted with the dust barrel 20 including the dust bag or the dust barrel 20 including the cyclone separator. That is, an external structure of the dust barrel 20 may be a general structure, the structure connected to the first mounting portion 13 may be a uniform structure, and the dust bag or the cyclone separator may be provided inside the dust barrel 20, so that the first mounting portion 13 may be selectively mounted with the dust barrel 20 including the dust bag or the dust barrel 20 including the cyclone separator.

In some embodiments, the first mounting portion 13 and the second mounting portion 14 are spaced from each other, so that the dust barrel 20 or the first filtering assembly 30 can be mounted on the body 10 firstly, or the dust barrel 20 and the first filtering assembly 30 can be mounted on the body 10 simultaneously. That is, the dust barrel 20 and the first filtering assembly 30 are mounted without a limitation by a mounting sequence, and may be mounted and detached arbitrarily as required, without interference between the components, thereby simplifying the structures and facilitating the mounting.

The first mounting portion 13 and the second mounting portion 14 may be distributed on two sides of the base 101 sequentially. In addition, two structures similar in appearance and structure are formed above the base 101 after the dust barrel 20 is mounted to the first mounting portion 13, and the first filtering assembly 30 is mounted inside the first mounting portion 13.

In some embodiments, the first detection member is a contact detection element or a non-contact detection element, and the second detection member is a contact detection element or a non-contact detection element.

In some embodiments, the first detection member may include a contact switch sensing element and a contact switch fitting element, and the second detection member may include a non-contact sensing element and a non-contact sensing and fitting element. The first mounting portion 13 is provided with a contact switch sensing element, and the dust barrel 20 is provided with a contact switch fitting element. The contact switch sensing element may be fitted with the contact switch fitting element when the dust barrel 20 is mounted to the first mounting portion 13, such that the contact switch sensing and fitting element can sense the contact switch sensing element. The second mounting portion 14 is provided with a non-contact sensing element, and the first filtering assembly 30 is provided with a non-contact sensing and fitting element. The non-contact sensing and fitting element may be fitted with the non-contact sensing element when the first filtering assembly 30 is mounted to the second mounting portion 14, such that the non-contact sensing and fitting element can sense the non-contact sensing element.

It should be noted that the contact detection element may be a contact sensor in the related art, such as a pressure sensor, a switch element, and the like. The non-contact detection element may be a non-contact sensor in the related art, such as a laser sensor, an inductive proximity sensor, and the like.

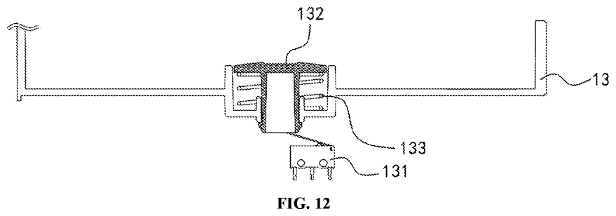

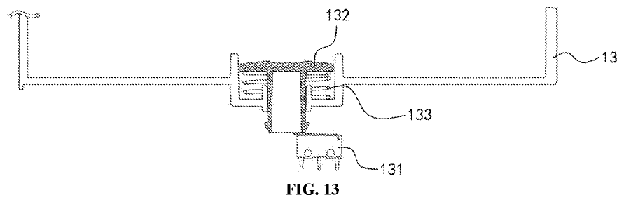

In some embodiments, as shown in FIGS. 12 and 13, the contact detection element includes: a switch 131 provided on the first mounting portion 13; and a detection button 132 provided opposite to the switch 131, so that the detection button 132 presses the switch 131 to be in a closed state when the dust barrel 20 and the first mounting portion 13 are mounted in position. That is, after the dust barrel 20 is mounted in position, the switch 131 is in the closed state, so as to output corresponding signals.

The switch 131 may be a conventional button connected onto a line, and the button can be turned on only when the detection button 132 presses in position, so as to achieve the conduction of the line, thereby enabling signal transmission.

In some embodiments, the detection button 132 may be provided on the dust barrel 20.

In some embodiments, the contact detection element further includes: an elastic member 133, where the elastic member 133 is provided on the first mounting portion 13, and the detection button 132 passes through and is provided within the elastic member 133. Among them, the elastic member 133 is located between the detection button 132 and the first mounting portion 13, so that the elastic member 133 drives the detection button 132 to release the switch 131 when the dust barrel 20 is disengaged from the first mounting portion 13, so as to enable the switch 131 to be in an open state. The detection button 132 may be provided on the first mounting portion 13 and moves downward depending on a pressure of the dust barrel 20. In addition, when the dust barrel 20 is disengaged from the first mounting portion 13 upward, the detection button 132 may move upward under the driving of the elastic member 133, so as to release the switch 131. The detection button 132 is provided with a position-limiting structure at a bottom end, thereby avoiding the detection button 132 from being disengaged from the first mounting portion 13.

In some embodiments, the switch 131 is provided on the second mounting portion 14, and the detection button 132 is provided opposite to the switch 131, so that the detection button 132 presses the switch 131 to be in the closed state when the first filtering assembly 30 and the second mounting portion 14 are mounted in position. That is, after the first filtering assembly 30 is mounted in position, the switch 131 is in the closed state, so as to output the corresponding signals.

In some embodiments, the detection button 132 may be provided on the first filtering assembly 30.

In some embodiments, the detection button 132 is provided on the second mounting portion 14, the elastic member 133 is provided on the second mounting portion 14, and the detection button 132 passes through and is provided within the elastic member 133. Among them, the elastic member 133 is located between the detection button 132 and the second mounting portion 14, so that the elastic member 133 drives the detection button 132 to release the switch 131 when the first filtering assembly 30 is disengaged from the second mounting portion 14, so as to enable the switch 131 to be in the open state.

In some embodiments, the elastic member 133 may be a spring.

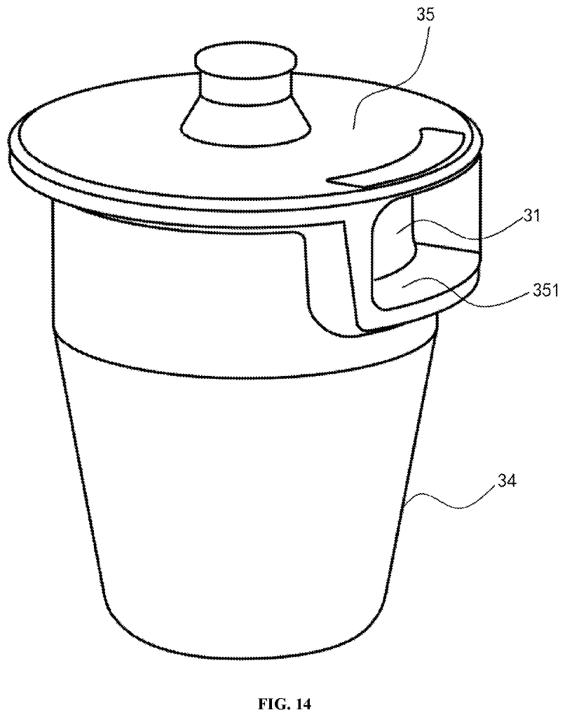

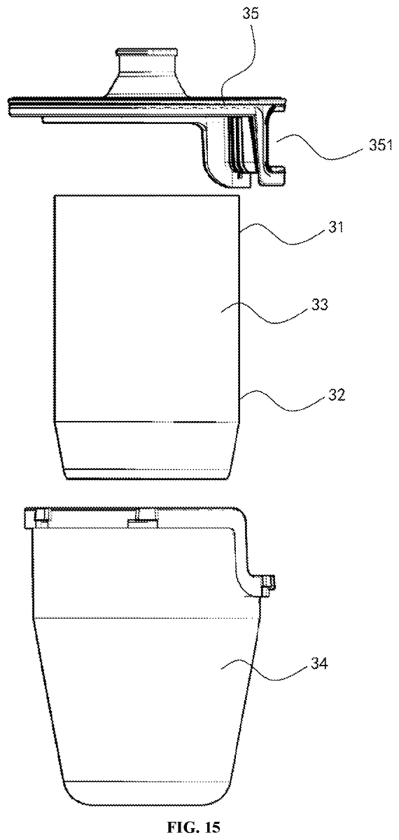

In some embodiments, as shown in FIGS. 14 and 15, the first filtering assembly 30 includes: a top cover 35 having an air inlet channel 351 that communicates the air inlet end 31 with a communication pipeline 17; and a filtering portion 34 provided on the top cover 35 and opposite to the air outlet end 32, such that the dust is filtered through the filtering portion 34, thereby avoiding the dust from entering the fan assembly 40.

In some embodiments, the filtering portion 34 may be of a filtering structure in the related art, such as a filter screen structure. A specific structure form, for example, may be a circular network structure, thereby enabling the filtering of the dust.

In some embodiments, as shown in FIG. 15, the filtering portion 34 is of a bagged structure. That is, a filtering area of the filtering portion 34 increases, and a filtering contact area increases, so as to improve the filtering effect. Moreover, the service life of the filtering portion 34 may be greatly prolonged due to the increase of the filtering area, thereby reducing a replacement frequency of the filtering portion 34.

It should be noted that the bagged structure may be understood as that the filtering portion 34 has an accommodation space, and the airflow is discharged from the filtering portion 34 after entering the accommodation space.

As shown in conjunction with FIG. 15, the first filtering assembly 30 further includes: a dust containing member 33, where the dust containing member 33 has an air inlet end 31 and an air outlet end 32, the dust containing member 33 is provided within the filtering portion 34, and the filtering portion 34 is provided opposite to the air outlet end 32, so that the airflow discharged from the air outlet end 32 enters the air inlet 41 of the fan assembly 40 after passing through the filtering portion 34. The dust containing member 33 can absorb the dust within the airflow, thereby achieving primary absorption of the dust within the airflow, and avoiding a large amount of dust from entering the filtering portion 34 to block the filtering portion 34.

In some embodiments, the dust containing member 33 includes a dust containing cotton. After entering the first filtering assembly 30, the airflow may pass through the dust containing cotton firstly. The dust containing cotton cannot intercept all the dusts within specifications, but can intercept some of larger particles to reduce the risk that the filtering portion 34 is blocked, thereby prolonging the service life of the whole first filtering assembly 30.

In some embodiments, the dust containing member 33 includes a sponge. The filtering portion 34 may be a filter screen, which may include a filtering cotton.

In some embodiments, as shown in FIG. 15, both the air inlet end 31 and the air outlet end 32 are located on an outer surface of the dust containing member 33, and an area of the air inlet end 31 is less than that of the air outlet end 32, so that the airflow can enter the dust containing member 33 from a relatively smaller surface to increase the length of a path that the airflow passes through the dust containing member 33, thereby increasing the absorption amount of the dust and further reducing the impact of the dust on the filtering portion 34.

In some embodiments, the filtering portion 34 encloses the dust containing member 33. The filtering portion 34 can not only implement the fixation of the dust containing member 33, but also enable the airflow flowing out of the dust containing portion 33 to be discharged directly through the filtering portion 34, thereby ensuring the filtering effect and simplifying the structure.

In some embodiments, the dust containing member 33 and the filtering portion 34 are provided on the top cover 35, so that the dust containing member 33 and the filtering portion 34 are fixed on the top cover 35.

In some embodiments, the top cover 35 of the first filtering assembly 30 may be connected to the body 10, so as to provide the first filtering assembly 30 on the body 10.

In some embodiments, at least one of the dust containing member 33 and the filtering portion 34 may be directly fixed on the top cover 35. That is, the dust containing member 33 may be connected to the top cover 35, and the filtering portion 34 may enclose the dust containing member 33. That is, the filtering portion 34 is connected to the dust containing member 33, and the filtering portion 34 may not be directly connected to the top cover 35.

In some embodiments, the filtering portion 34 is connected to the top cover 35 to form an accommodation space between the filtering portion 34 and the top cover 35, and the dust containing member 33 is located within the accommodation space. That is, the dust containing member 33 is fixed within the accommodation spaced formed between the filtering portion 34 and the top cover 35.

In some embodiments, the filtering portion 34 is detachably provided on the top cover 35, so as to facilitate replacing the filtering portion 34 and the dust containing member 33. The filtering portion 34 and the top cover 35 may be snap-fitted, adhered or connected by a fastener, which is not defined here as long as they are easy to be detached and mounted.

In some embodiments, an area of the top cover 35 covering the dusting containing member 33 is less than that of the filtering portion 34 covering the dust containing member 33, so that the air inlet end 31 of the dust containing member 33 is smaller than the air outlet end 32, thereby ensuring that the airflow flows out rapidly, and the dust containing member 33 implements absorption of the dust to the maximum extent.

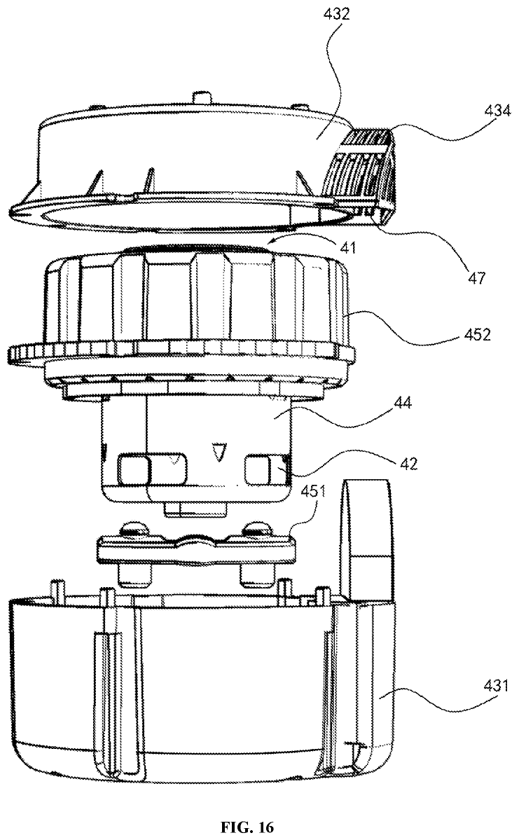

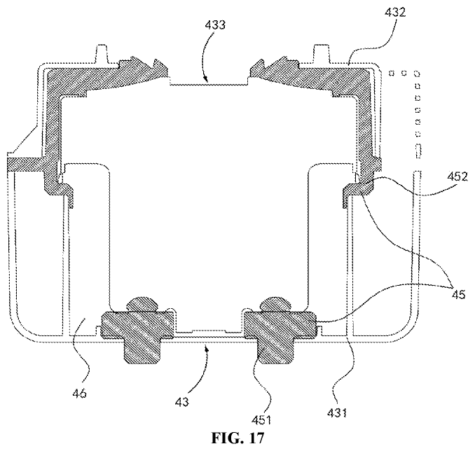

In some embodiments, as shown in FIGS. 16 and 17, the fan assembly 40 includes: a housing 43, a fan 44, and a flexible member 45.

The housing 43 is provided on the body 10, the flexible member 45 is located between the housing 43 and the fan 44, the fan 44 is fixed within the housing 43 by the flexible member 45, and the flexible member 45 avoids a direct contact between the fan 44 and the housing 43. The arrangement of the flexible member 45 may avoid the direct contact between the fan 44 and the housing 43, thereby avoiding large noise. In addition, since the fan 44 is fixed within the housing 43 by the flexible member 45, the housing 43 may be enabled to adapt to the fans 44 of different types as long as the flexible member 45 is replaced, thereby improving the generality of the housing 43.

In some embodiments, a mounting cavity is formed with a mounting cavity, both the fan assembly 40 and the first filtering assembly 30 are provided within the mounting cavity. A partition plate is provided between the fan assembly 40 and the first filtering assembly 30. A second channel 18 is provided on the partition plate. The second channel 18 communicates the air outlet end 32 of the first filtering assembly 30 with the air inlet 41 of the fan assembly 40, so as to ensure that the airflow discharged through the first filtering assembly 30 only enters the air inlet 41 of the fan assembly 40 through the second channel 18, which is specifically as shown in FIGS. 9 and 10. The body 10 implements the protection of the fan assembly 40 and the first filtering assembly 30, and avoids the fan assembly 40 and the first filtering assembly 30 from being exposed to an external environment.

According to the fan assembly 40 in the embodiments, by locating the flexible member 45 between the housing 43 and the fan 44, a hard contact between the housing 43 and the fan 44 is avoided, so as to avoid producing large noise. In addition, since the housing 43 and the fan 44 are not connected directly, the fans 44 of different sizes may be mounted within the housing 43 according to usage requirements, so as to improve the generality of the housing 43.

In some embodiments, as shown in FIGS. 16 and 17, the housing 43 includes: a first housing member 431; and a second housing member 432, where the second housing member 432 is detachably connected to the first housing member 431 to release or fix the fan 44 and the flexible member 45, which facilitates not only the mounting of the fan 44 and the flexible member 45 but also subsequent maintenance and replacement. In addition, the fans 44 of different types may be selected to replace the fans 44 of the original type, and only does the flexible member 45 need to be adaptively replaced, thereby achieving the generality of the housing 43.

In some embodiments, the second housing member 432 is connected to the first housing member 431 in a sealed manner, and the second housing member 432 may be connected to the first housing member 431 through a plurality of fasteners.

In some embodiments, as shown in FIG. 17, the flexible member 45 includes: a first flexible portion 451 provided between the fan 44 and the first housing member 431 to support the fan 44; and a second flexible portion 452, at least a part of the second flexible portion 452 being provided between the fan 44 and the second housing member 432 to clamp the fan 44 together with the first flexible portion 451. The second flexible portion 452 can be filled between the fan 44 and the second housing member 432, so as to avoid the fan 44 from moving relative to the second housing member 432 and ensure that the fan 44 is fixed within the second housing member 432. The first flexible portion 451 can be filled between the fan 44 and the first housing member 431, so as to avoid the fan 44 from moving relative to the first housing member 431 and ensure that the fan 44 is fixed within the first housing member 431. The first flexible portion 451 and the first flexible portion 451 implement the fixation of the fan 44 and completely avoid a hard contact between the fan 44 and the housing 43.

In some embodiments, the first flexible portion 451 may be connected to the second flexible portion 452.

In some embodiments, the first flexible portion 451 is provided separately from the second flexible portion 452. That is, during mounting, the first flexible portion 451 and the fan 44 may be provided within the first housing member 431 firstly, the second flexible portion 452 and the second housing member 432 are then snap-fitted onto the fan 44 and the first housing member 431, and the second housing member 432 and the first housing member 431 are fixed, so as to complete the mounting of the fan assembly 40.

In some embodiments, a part of the second flexible portion 452 is clamped between the first housing member 431 and the second housing member 432 to seal a gap between the first housing member 431 and the second housing member 432, so as to avoid sealing the first housing member 431 and the second housing member 432 by using other sealing members, which is simple in structure and may reduce mounting steps.

In some embodiments, the first flexible portion 451 is a rubber pad, and the second flexible portion 452 is a rubber sleeve. The rubber pad is supported between the fan 44 and the first housing member 431, and the rubber sleeve is sleeved over an upper portion of the fan 44, so as to protect the fan 44.

In some embodiments, the second housing member 432 is provided with an airflow through hole 433, where the airflow through hole 433 is communicated with the air inlet 41 of the fan 44, and there is a clearance between the first housing member 431 and the fan 44. Among them, an air discharging channel 46 is formed among the first flexible portion 451, the second flexible portion 452, the first housing member 431, and the fan 44; and, the air discharging channel 46 is communicated with the air outlet 42 of the fan 44. The airflow discharged from the first filtering assembly 30 enters the air inlet 41 of the fan 44 through the airflow through hole 433, and is discharged into the air discharging channel 46 through the air outlet 42 of the fan 44, and finally is discharged from the air discharging channel 46, so as to achieve the circular flowing of the airflow.

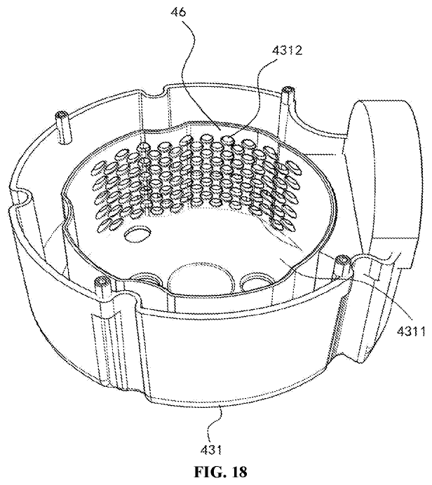

As shown in FIG. 18, the first housing member 431 has a space 4311 for accommodating the fan 44, and a plurality of vent holes 4312 is formed in a side wall of the space 4311. That is, the airflow within the air discharging channel 46 is discharged through the vent holes 4312, and the vent holes 4312 occupy a part of the first housing member 431 in a circumferential direction, so that the circular flowing of the airflow within the air discharging channel 46 may be achieved. The first housing member 431 has a housing member with an inside and an outside being sleeved with each other. An airflow space formed between the housing member with an inside and an outside being sleeved with each other is communicated with the air discharging channel 46 through the vent holes 4312, and the airflow is finally discharged from the fan assembly 40.

In some embodiments, the fan assembly 40 further includes an air discharging hole 434. The air discharging hole 434 is communicated with the air discharging channel 46, so as to discharge the airflow within the air discharging channel 46 out of the fan assembly 40.

In some embodiments, the air discharging hole 434 is provided on the housing 43, so as to discharge the airflow within the air discharging channel 46. In some embodiments, the air discharging hole 434 may be provided on the first housing member 431, that is, the airflow within the air discharging channel 46 may be discharged out of the fan assembly 40 without providing a hole on the second flexible portion 452. The air discharging hole 434 may also be provided on the second housing member 432, that is, a hole may be provided on the second flexible portion 452 to communicate the air discharging hole 434 with the air discharging channel 46. The position of the air discharging hole 434 may not be defined, as long as it is ensured that the airflow can be discharged out of the air discharging channel 46.

In some embodiments, as shown in FIG. 16, the fan assembly 40 further includes: a silencer 47, where the silencer 47 is provided on the housing 43, an inlet of the silencer 47 is communicated with the air discharging hole 434, or an outlet of the silencer 47 is communicated with the air discharging hole 434, so that the airflow discharged out of the air discharging channel 46 are silenced through the silencer 47, so as to reduce noise caused by the airflow.

In some embodiments, the silencer 47 may be provided inside the housing 43, the air discharging channel 46 may be communicated with the inlet of the silencer 47, and the outlet of the silencer 47 may be communicated with the air discharging hole 434, so that the airflow passes through the silencer 47 firstly and then is discharged out of the housing 43.

In some embodiments, the silencer 47 may be provided outside the housing 43, the air discharging channel 46 may be communicated with the air discharging hole 434, and the air discharging hole 434 may be communicated with the inlet of the silencer 47, so that the airflow is discharged out of the housing 43 firstly and then silenced through the silencer 47.

In some embodiments, the air discharging channel 46 is provided around a circumferential outer surface of the fan 44, and the length of the air discharging channel 46 extending along the circumferential outer surface of the fan 44 is greater than that of the air discharging hole 434 extending along the circumferential outer surface of the fan 44. That is, the airflow discharged from the fan 44 is discharged out of the housing 43 only through a relatively fixed position, so that the airflow may rotate within the air discharging channel 46 for nearly one revolution, and then is discharged through the air discharging hole 434. As such, noise may be reduced by prolonging the airflow path.

In some embodiments, nearly a circle of the air outlets 42 may be formed on the circumferential outer surface of the fan 44, meanwhile the air discharging channel 46 also forms nearly a circle of surrounding space, so that the airflows from the air outlets 42 at respective positions can be directly discharged into the air discharging channel 46. At this point, the air discharging hole 434 on the housing 43 may be located in a circumferential direction of the housing 43, or may also be provided at a top of the housing 43, and at this point, the air discharging channel 46 may be communicated with the air discharging hole 434 through a pipeline, so as to ensure that the airflow discharged from the air discharging channel 46 need to rotate to a relatively fixed position for discharge, thereby reducing noise by increasing the airflow path.

In some embodiments, as shown in FIGS. 7-9, the dust collection pile further includes a second filtering assembly 50, where the second filtering assembly 50 is provided around the first filtering assembly 30, and an air collection port 51 of the second filtering assembly 50 is communicated with the air outlet 42 of the fan assembly 40. That is, the airflow discharged from the air outlet 42 of the fan assembly 40 need to be filtered firstly through the second filtering assembly 50 and then discharged, thereby ensuring that the discharged airflow is clean.

In some embodiments, the second filtering assembly 50 may be of a conventional filtering structure, that is, may include a filter screen, so as to achieve secondary filtering of the airflow and ensure that the discharged airflow is clean. For example, the second filtering assembly 50 may be of an annular structure, namely, a circumferential closed structure, so as to be provided around the first filtering assembly 30. The airflow enters the fan assembly 40 from the first filtering assembly 30, which belongs to flowing from top to bottom, and then, the airflow enters the second filtering assembly 50 from the fan assembly 40, which belongs to flowing from bottom to top.

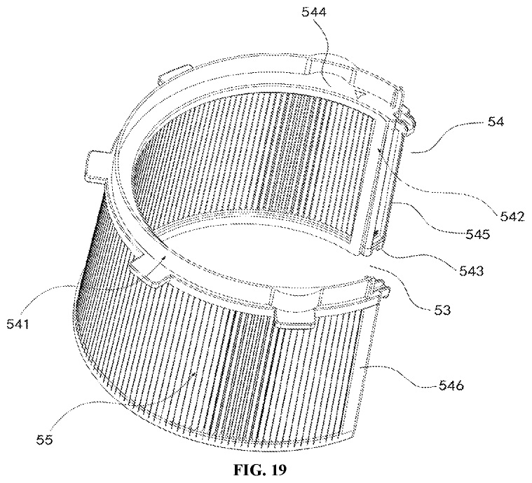

In some embodiments, as shown in FIG. 19, the second filtering assembly 50 is provided with an opening 53. That is, the second filtering assembly 50 may be of a circumferential non-closed structure.

In some embodiments, the dust collection pile further includes an air inlet conduit 80. One end of the air inlet conduit 80 is communicated with the dust inlet channel 11, and the other end of the air inlet conduit 80 is communicated with the dust inlet end 21. The opening 53 can evade the air inlet conduit 80.

In some embodiments, the body 10 further includes a communication pipeline 17. Two ends of the communication pipeline 17 are respectively communicated with the air inlet end 31 of the first filtering assembly 30 and the airflow outlet end 22 of the dust barrel 20. The opening 53 can evade the communication pipeline 17, so as to ensure the compactness of the structure.

In some embodiments, as shown in FIGS. 7 and 10, the body 10 is provided with a first channel 15. The first channel 15 communicates the air collection port 51 of the second filtering assembly 50 with the air outlet 42 of the fan assembly 40.

As shown in FIG. 10, the body 10 is provided with a mounting groove 16, the second mounting portion 14 has an accommodation groove for mounting the first filtering assembly 30, the mounting groove 16 is provided around the second mounting portion 14, and the second filtering assembly 50 is located within the mounting groove 16. The first channel 15 is communicated with the mounting groove 16, where the mounting groove 16 surrounds a part of the second mounting portion 14, and thus, may be adapted to the second filtering assembly 50 having the opening 53. A corresponding space within the opening 53 is used to form the space where the communication pipeline 17 and the air inlet conduit 80 are provided.

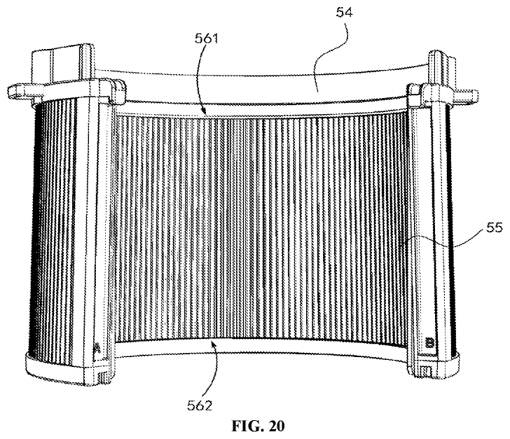

In some embodiments, as shown in FIGS. 20-22, the second filtering assembly 50 includes a frame 54 and a filter screen 55, where the filter screen 55 is provided on the frame 54, and an evasion groove 56 is formed in the filter screen 55. The evasion groove 56 includes a first opening 561, a second opening 562, and a third opening 563, where the first opening 561 is provided opposite to the second opening 562, and two ends of the third opening 563 penetrate through the first opening 561 and the second opening 562. As a supporting structure for the second filtering assembly 50, the frame 54 ensures the stability of the second filtering assembly 50. The frame 54 is provided on the body 10, and the evasion groove 56 accommodates the second mounting portion 14 that accommodates the first filtering assembly 30, so that the airflow discharged from the fan assembly 40 enters between the second filtering assembly 50 and the second mounting portion 14.

It should be noted that the evasion groove 56 includes the first opening 561, the second opening 562, and the third opening 563, where the first opening 561 is provided opposite to the second opening 562, and two ends of the third opening 563 penetrate through the first opening 561 and the second opening 562. That is, the frame 54 is adapted to the filter screen 55, so that the opening 53 is formed on the second filtering assembly 50. The overall structure of the second filtering assembly 50 may be similar to a C-shaped structure or may be a U-shaped structure, which is not defined here and may be determined according to the specific structure form of the second mounting portion 14, thereby ensuring the reasonable distribution of the components.

In some embodiments, the filter screen 55 is an arc-shaped filter screen. That is, on the premise of ensuring an effective filtering area, the structure of the filter screen 55 may be reduced to the maximum extent, so as to be adapted to the circumferential outer surface of the second mounting portion 14.

In some embodiments, an area of the third opening 563 is less than that of the filter screen 55. That is, it is ensured that the filter screen 55 has a sufficient filtering area.

In some embodiments, as shown in FIG. 19, the frame 54 includes: a frame body 541 on which the filter screen 55 is provided; and a sealing member 542, where the sealing member 542 is provided inside the frame body 541, and a circumferential closed space is formed by the sealing member 542 to expose at least a part of the filter screen 55. The frame body 541 is configured to fix the filter screen 55, and the sealing member 542 may be fitted with the second mounting portion 14 to ensure that there is no gap between the sealing member 542 and the second mounting portion 14, thereby ensuring that the airflow must be discharged out after passing through the filter screen 55.

In some embodiments, the sealing member 542 includes a Hepa paper.

In some embodiments, as shown in FIG. 19, the frame body 541 includes a first support 543 and a second support 544. The second support 544 is provided opposite to the first support 543, the filter screen 55 is connected between the second support 544 and the first support 543, and the sealing member 542 is provided on inner sides of the second support 544 and the first support 543. The sealing member 542 may not only be used for sealing, but also implement the connection of the second support 544 and the first support 543.

In some embodiments, the frame body 541 further includes: a first connecting section 545, two ends of the first connecting section 545 being connected to the first support 543 and the second support 544 respectively; and, a second connecting section 546, two ends of the second connecting section 546 being connected to the first support 543 and the second support 544 respectively. The first connecting section 545 is provided opposite to the second connecting section 546; and, the first support 543, the second support 544, the first connecting section 545, and the second connecting section 546 form a mounting space, within which the filter screen 55 is located.

In some embodiments, the filter screen 55 includes a sealing foam.

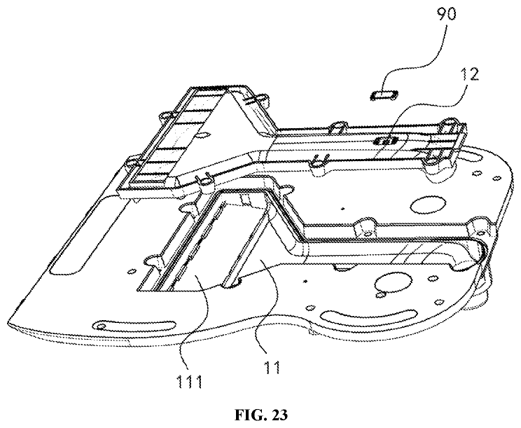

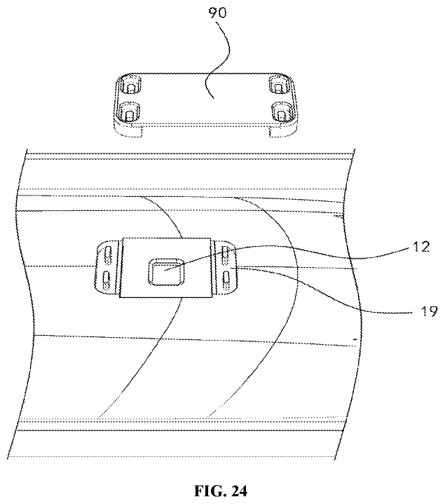

In some embodiments, as shown in FIGS. 23 and 24, the body 10 further includes a liquid outlet hole 12, where the liquid outlet hole 12 is provided on the base 101, and one end of the liquid outlet hole 12 is communicated with the dust inlet channel 11. Furthermore, the liquid outlet hole 12 is located at the bottom of the body 10.

As shown in FIGS. 23 and 24, the dust collection pile further includes a shielding member 90 movably provided on the body 10, so that the shielding member 90 has a sealed position in which the liquid outlet hole 12 is shielded and an open position in which the liquid outlet hole 12 is released. Among them, during the process of the dust of the dust box entering the dust inlet channel 11, the shielding member 90 is in the sealed position, and when the dust of the dust box stops entering the dust inlet channel 11, the shielding member 90 can move to the open position, so that the dust inlet channel 11 is communicated with the outside through the liquid outlet hole 12.

During the process of the dust of the dust box entering the dust inlet channel 11, it is necessary to ensure that the dust inlet channel 11 forms a negative pressure environment, so that the shielding member 90 closes the liquid outlet hole 12 to ensure that the dust inlet channel 11 is not communicated with the outside. However, when the dust of the dust box stops entering the dust inlet channel 11, the shielding member 90 may be opened, so that the dust inlet channel 11 is communicated with the outside, and liquid entering the dust inlet channel 11 may be discharged out of the dust inlet channel 11 through the liquid outlet hole 12, thus ensuring, to the maximum extent, that the inside of the dust inlet channel 11 is dry.

It should be noted that “the outside” described above may be understood as an external environment space, or may also be other spaces independent from the dust inlet channel 11. For example, a liquid collector may be provided to enable the liquid within the dust inlet channel 11 to flow into the liquid collector. At this point, the space formed by the liquid collector may also be understood as the outside.

In some embodiments, the shielding member 90 is movably provided on the body 10, and the shielding member 90 may be driven by a driving mechanism to move, so as to achieve closing and releasing of the liquid outlet hole 12. In some embodiments, the driving mechanism may be an air cylinder, an oil cylinder or an electric cylinder, where a telescopic rod of the driving mechanism may drive the shielding member 90 to move relative to the liquid outlet hole 12, thereby achieving the closing and releasing of the liquid outlet hole 12. In some embodiments, the driving mechanism may include a motor, and the shielding member 90 is driven by the motor to rotate relative to the body 10, thereby achieving the closing and releasing of the liquid outlet hole 12.

It should be noted that, the fan assembly 40 starts to clean the dust within the dust box starts when running, and the shielding member 90 can rotate from the open position to the sealed position. In some embodiments, the control portion of the dust collection pile may control the above driving mechanism to drive the shielding member 90 to move from the open position to the sealed position prior to controlling the fan assembly 40 to run, or the control portion may control the fan assembly 40 and the above driving mechanism to run simultaneously. In addition, the fan assembly 40 stops cleaning the dust within the dust box when it stops running, and the shielding member 90 can rotate from the sealed position to the open position. In some embodiments, the control portion of the dust collection pile may control the above driving mechanism to drive the shielding member 90 to move from the sealed position to the open position after controlling the fan assembly 40 to stop running, or the control portion may control the above driving mechanism to run while controlling the fan assembly 40 to stop running.

In some embodiments, the shielding member 90 may be connected onto the body 10, and the movement of the shielding member 90 does not depend on the driving mechanism. The shielding member 90 can rotate from the open position to the sealed position under the driving of the fan assembly 40. That is, when the fan assembly 40 is running, depending on the negative pressure generated by the fan assembly 40, the shielding member 90 may be driven to move from the open position to the sealed position. In addition, when the fan assembly 40 stops running, the shielding member 90 can rotate from the sealed position to the open position under the action of gravity.

In some embodiments, the shielding member 90 may be provided on a plate body, and this plate body is rotatably provided on the body 10, so as to ensure that the shielding member 90 rotates from the sealed position to the open position under the action of gravity.

In some embodiments, the liquid outlet hole 12 is communicated with one side of the dust inlet channel 11 close to the dust barrel 20. That is, when the fan assembly 40 is running, the liquid may flow from the dust inlet 111 to the dust barrel 20 along with the dust inlet channel 11. Therefore, after the fan assembly 40 stops running, most of the liquid is gathered at one side close to the dust barrel 20. At this point, the liquid can flow out conveniently from the liquid outlet hole 12 by opening the liquid outlet hole 12.

In some embodiments, as shown in FIG. 24, the body 10 is provided with a sealing groove 19, and one end of the liquid outlet hole 12 is located within the sealing groove 19. When the shielding member 90 is in the sealed position, the shielding member 90 is located within the sealing groove 19, and the shielding member 90 implements sealing of the liquid outlet hole 12 reliably at this point.

In some embodiments, when the shielding member 90 is in the sealed position, the shielding member 90 may be in a clearance fit with a side wall of the sealing groove 19 and may be stopped on the liquid outlet hole 12 reliably, so as to achieve the sealing of the liquid outlet hole 12.

In some embodiments, when the shielding member 90 is in the sealed position, the shielding member 90 may be in an interference fit with the side wall of the sealing groove 19. That is, the shielding member 90 seals the sealing groove 19, so as to achieve the sealing of the liquid outlet hole 12.

It should be noted that the sealing groove 19 may be provided on one side of the liquid outlet hole 12 close to the dust inlet channel 11. That is, the sealing groove 19 is located within the dust inlet channel 11. At this point, the shielding member 90 may be driven by the driving mechanism to move.

In some embodiments, the sealing groove 19 may be provided on one side of the liquid outlet hole 12 away from the dust inlet channel 11. That is, the sealing groove 19 is located outside the dust inlet channel 11. At this point, the shielding member 90 may be driven by the fan assembly 40 to move, and the shielding member 90 may be disengaged from the sealing groove 19 under the action of gravity.

In some embodiments, the shielding member 90 is provided on a plate body. This plate body enables the shielding member 90 to be disengaged from the sealing groove 19 under the action of gravity when the fan assembly 40 does not work. The plate body may be driven to rotate only when the fan assembly 40 works, so that the shielding member 90 is located within the sealing groove 19, so as to achieve the sealing of the liquid outlet hole 12.

In some embodiments, the shielding member 90 is rotatably provided on the body 10, so that the shielding member 90 can be switched between the sealed position and the open position. The shielding member 90 may be rotated by the driving mechanism relative to the body 10, so as to seal or release the liquid outlet hole 12. In some embodiments, the shielding member 90 may be enabled to rotate under the action of the fan assembly 40, and may rotate from the sealed position to the open position under the action of gravity.

In some embodiments, the shielding member 90 is provided on one side of the body 10 away from the dust inlet channel 11. That is, the shielding member 90 may rotate from the sealed position to the open position under the action of gravity.

In some embodiments, at least a part of the shielding member 90 is a flexible member, which not only has strong structure stability, but also can better achieve the sealing of the liquid outlet hole 12. In some embodiments, at least a part of the shielding member 90 is rubber, and the shielding member 90 may be a soft rubber sheet. After the fan assembly 40 runs and generates the negative pressure to suck up the soft rubber sheet, the liquid outlet hole 12 is blocked to achieve a sealing effect. When the fan assembly 40 does not work, the soft rubber sheet returns to its original position, and the liquid may flow out of the dust inlet channel 11 through the liquid outlet hole 12, so as to avoid the retention of a large amount of liquid within the dust inlet channel 11.

In some embodiments, the liquid outlet hole 12 may be a circular hole, a triangular hole or a rectangular hole. Of course, the liquid outlet hole 12 may also be an irregularly-shaped hole, which is not defined here. In addition, a specific structural shape of the sealing groove 19 for accommodating the shielding member 90 may also be circular, triangular or rectangular. Of course, the sealing groove 19 may also be an irregularly-shaped groove.

In some embodiments, a plurality of liquid outlet holes 12 is provided to increase a rate at which the liquid flows out and ensure that the liquid within the dust inlet channel 11 flows out reliably.

In some embodiments, at least one shielding member 90 is provided, where one shielding member 90 can shield a plurality of liquid outlet holes 12, so as to simplify the structure.

In some embodiments, a plurality of shielding members 90 is provided in a one-to-one correspondence to the plurality of liquid outlet holes 12 to ensure that each shielding member 90 seals each liquid outlet hole 12 independently, thereby increasing the reliability of sealing.

In some embodiments, as shown in FIG. 9, the dust collection pile further includes a spoiler 60, where the spoiler 60 is provided around the second filtering assembly 50, and the spoiler 60 is provided opposite to an air outlet surface 52 of the second filtering assembly 50, thereby forming a spoiler channel 61. Among them, an air outlet channel 62 is formed between the spoiler 60 and the body 10, and a bottom end of the spoiler channel 61 is communicated with a bottom end of the air outlet channel 62. That is, the airflow discharged from the air outlet surface 52 of the second filtering assembly 50 can flow downward under the blocking of the spoiler 60, and flow from the bottom of the spoiler channel 61 into the air outlet channel 62. Therefore, the airflow path may be increased, thereby achieving an effect of noise reduction.

In some embodiments, as shown in FIG. 9, the spoiler 60 includes a first surface 63 and a second surface 64 opposite to each other, where the first surface 63 is provided opposite to the air outlet surface 52 of the second filtering assembly 50 to form the spoiler channel 61, and the second surface 64 is provided opposite to the body 10 to form the air outlet channel 62. Among them, the bottom end of the spoiler channel 61 is communicated with the bottom end of the air outlet channel 62, so that the airflow discharged from the air outlet surface 52 can enter the air outlet channel 62 from the bottom end of the spoiler channel 61, thereby increasing the airflow path.

In some embodiments, at least one of the body 10 and the second filtering assembly 50 is connected to the spoiler 60, for fixing the spoiler 60, thereby ensuring that the spoiler 60 stably implements airflow guidance.

In some embodiments, the upper side of the spoiler 60 is connected to at least one of the body 10 and the second filtering assembly 50 to avoid that a top end of the spoiler channel 61 is directly communicated with the top end of the air outlet channel 62. That is, the airflow is prevented from flowing directly from the top end of the spoiler channel 61 into the air outlet channel 62.

In some embodiments, the spoiler 60 may be connected onto the body 10, so that a sealed connection is formed between the top end of the spoiler 60 and the body 10.

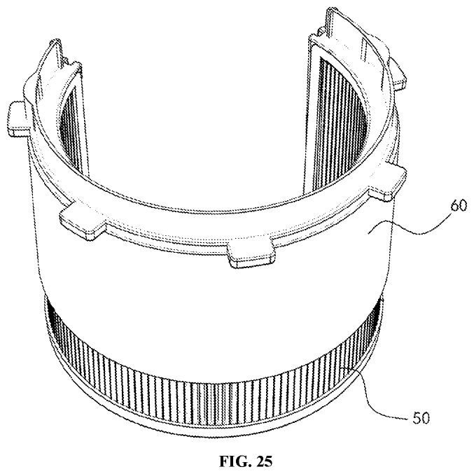

In some embodiments, as shown in conjunction with FIGS. 25-28, the top of the spoiler 60 is fixedly connected to the second filtering assembly 50. That is, the top of the spoiler 60 may be connected to the frame 54 of the second filtering assembly 50, so that a sealed connection is formed between the top end of the spoiler 60 and the second filtering assembly 50.

In some embodiments, the bottom end of the spoiler 60 is provided in a suspended manner, so that the bottom end of the spoiler channel 61 is communicated with the bottom end of the air outlet channel 62. That is, both the second filtering assembly 50 and the body 10 may not be in contact with the bottom end of the spoiler 60, so that the airflow enters the air outlet channel 62 along the bottom end of the spoiler 60.

In some embodiments, the bottom end of the spoiler 60 may be lower than the bottom end of the air outlet surface 52, as long as it is ensured that a sealed connection is not formed between the bottom end of the spoiler 60 and the body 10.

In some embodiments, the bottom end of the spoiler 60 is higher than the bottom end of the air outlet surface 52. That is, a part of the airflow discharged from the air outlet surface 52 may not be stopped by the spoiler 60 as well.

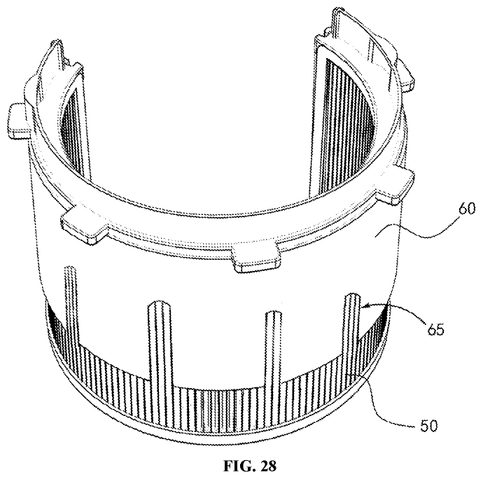

In some embodiments, as shown in FIG. 28, the spoiler 60 is provided with a communication channel 65, and the spoiler channel 61 is also communicated with the air outlet channel 62 through the communication channel 65. That is, the communication channel 65 may directly enable a part of the airflow to enter the air outlet channel 62, thereby preventing a large amount of airflows from directly impacting the spoiler 60. Therefore, the noise caused by airflow impacting may also be avoided on the basis of ensuring that flowing paths of a part of the airflow are increased.

In some embodiments, the communication channel 65 is a through hole, which is located in a middle portion of the spoiler 60. That is, the spoiler channel 61 is also communicated with the air outlet channel 62 through the through hole.

In some embodiments, the communication channel 65 is a notch, which recesses upward from the bottom end of the spoiler 60. That is, it can be understood as that an opening is formed in the spoiler 60 to release the airflow directly.

In some embodiments, a plurality of communication channels 65 is provided to ensure that the airflows at different positions can enter the air outlet channel 62 directly through the communication channel 65.

In some embodiments, the air outlet surface 52 includes a curved surface, the spoiler 60 includes an arc-shaped plate provided opposite to the curved surface, the plurality of communication channels 65 is provided along a circumferential direction of the arc-shaped plate at intervals, and a shape of the spoiler 60 is adapted to the air outlet surface 52, which may not only ensure reliable filtering, but also enable the structure to have a reasonable layout.

In some embodiments, as shown in FIGS. 2 and 6, the dust collection pile further includes: an air outlet plate 70, where the air outlet plate 70 is provided above the second filtering assembly 50, the air outlet plate 70 is provided with a through hole 71, and the through hole 71 is communicated with the top end of the air outlet channel 62. That is, the airflow entering the air outlet channel 62 flows upward, and thus, is discharged through the through hole 71 on the air outlet plate 70. Under the action of the spoiler 60, the airflow may be formed from top to bottom, and then, discharged from bottom to top, thereby achieving the purpose of noise reduction by increasing the airflow path greatly.

In some embodiments, the through hole 71 of the air outlet plate 70 may be communicated with the air outlet surface 52 of the second filtering assembly 50 directly. That is, the spoiler 60 may be removed, and the airflow out of the air outlet surface 52 of the second filtering assembly 50 may be discharged from the through hole 71 of the air outlet plate 70 directly.

As shown in FIG. 2, the dust collection pile further includes first charging contact tabs 103, and the cleaning robot further includes second charging contact tabs. The first charging contact tabs 103 are electrically connected to the second charging contact tabs to enable the dust collection pile to charge the cleaning robot. The first charging contact tabs 103 may be provided on the body 10. Furthermore, the first charging contact tabs 103 may be provided on the base 101. In addition, the first charging contact tabs 103 are located on the same surface as the dust inlet 111, and the first charging contact tabs 103 and the dust inlet 111 are provided at intervals.

In some embodiments, both a plurality of first charging contact tabs 103 and a plurality of second charging contact tabs are provided in pairs.

The cleaning robot needs to be moved onto the body 10 for subsequent dust box cleaning or charging.

In some embodiments, the cleaning robot may move along the body 10. That is, the cleaning robot may perform a movement onto a pile. The movement onto a pile may be understood as follows: when a distance between the cleaning robot and the body 10 is less than a certain threshold, for example, when the cleaning robot has reached the vicinity of the body 10, the cleaning robot may move towards a certain direction more apparent. In addition, a direction of advance for the movement onto a pile may be understood as follows: in order that the dust box discharges the dust into the dust inlet channel 11 or the second charging contact tabs are in contact with the first charging contact tabs 103, the cleaning robot moves from a first position point to a second position point, and a direction pointing from the first position point to the second position point is the direction of advance for the movement onto a pile.

All embodiments of the present disclosure may be performed independently, and may also be performed in combination with other embodiments, both of which are considered to fall within the protection scope claimed in the present disclosure. Other embodiments of the present disclosure may be easily conceivable to those skilled in the art after considering the specification and practicing the present disclosure here. The present disclosure is intended to cover any variants, usages or adaptive changes to the present disclosure. These variants, uses or adaptive changes follow the general principles of the present disclosure and include common knowledge or conventional technical means in the art not disclosed in the present disclosure. The specification and exemplary embodiments are considered to be exemplary merely. The true scope and spirit of the present disclosure is indicated by the appended claims.

It should be understood that the present disclosure is not limited to the precise structures that have been described above and shown in the accompanying drawings, and various modifications and changes can be made thereto without departing from the scope thereof. The protection scope of the present disclosure is only limited by the appended claims.

1. A fan assembly, comprising:
a housing;
a fan; and
a flexible member located between two ends of the fan and the housing, the fan being fixed within the housing by the flexible member, and the flexible member being configured to avoid a direct contact between the fan and the housing.

2. The fan assembly according to claim 1, wherein the housing comprises:
a first housing member; and
a second housing member, detachably connected to the first housing member to release or fix the fan and the flexible member.

3. The fan assembly according to claim 2, wherein the flexible member comprises:
a first flexible portion, provided between the fan and the first housing member to support the fan; and
a second flexible portion, at least a part of the second flexible portion being provided between the fan and the second housing member to clamp the fan together with the first flexible portion.

4. The fan assembly according to claim 3, wherein the first flexible portion is provided independently from the second flexible portion.

5. The fan assembly according to claim 3, wherein a part of the second flexible portion is clamped between the first housing member and the second housing member to seal a gap between the first housing member and the second housing member.

6. The fan assembly according to claim 4, wherein the first flexible portion is a rubber pad, and the second flexible portion is a rubber sleeve.

7. The fan assembly according to claim 3, wherein:
the second housing member is provided with an airflow through hole, the airflow through hole is communicated with an air inlet of the fan, and there is a clearance between the first housing member and the fan; and
an air discharging channel is formed among the first flexible portion, the second flexible portion, the first housing member, and the fan; and, the air discharging channel is communicated with an air outlet of the fan.

8. The fan assembly according to claim 7, further comprising an air discharging hole, wherein the air discharging hole is communicated with the air discharging channel.

9. The fan assembly according to claim 7, further comprising a silencer, wherein the silencer is provided on the housing, and one of an inlet of the silencer and an outlet of the silencer is communicated with the air discharging hole.

10. (canceled)

11. The fan assembly according to claim 7, wherein the air discharging channel is provided around a circumferential outer surface of the fan, and a length of the air discharging channel extending along the circumferential outer surface of the fan is greater than a length of the air discharging hole extending along the circumferential outer surface of the fan.

12. A dust collection pile, comprising:
a body, comprising a dust inlet channel, the dust inlet channel having a dust inlet connected to a dust box;
a dust barrel, detachably provided on the body, a dust inlet end of the dust barrel being communicated with the dust inlet channel to collect dust entering through the dust inlet channel; and
a fan assembly, provided on the body, an air inlet of the fan assembly being communicated with an airflow outlet end of the dust barrel, and the fan assembly running and generating a negative pressure, such that the dust within the dust box is able to enter the dust inlet channel through the dust inlet and an airflow is enabled to circulate; wherein, the fan assembly comprises:
a housing;
a fan; and
a flexible member, located between two ends of the fan and the housing, the fan being fixed within the housing by the flexible member, and the flexible member being configured to avoid a direct contact between the fan and the housing.

13. The dust collection pile according to claim 12, wherein the housing comprises:
a first housing member; and
a second housing member, detachably connected to the first housing member to release or fix the fan and the flexible member.

14. The dust collection pile according to claim 13, wherein the flexible member comprises:
a first flexible portion, provided between the fan and the first housing member to support the fan; and
a second flexible portion, at least a part of the second flexible portion being provided between the fan and the second housing member to clamp the fan together with the first flexible portion.

15. The dust collection pile according to claim 14, wherein:
the first flexible portion is provided independently from the second flexible portion; and
the first flexible portion is a rubber pad, and the second flexible portion is a rubber sleeve.

16. The dust collection pile according to claim 14, wherein a part of the second flexible portion is clamped between the first housing member and the second housing member to seal a gap between the first housing member and the second housing member.

17. (canceled)

18. The dust collection pile according to claim 14, wherein:
the second housing member is provided with an airflow through hole, the airflow through hole is communicated with an air inlet of the fan, and there is a clearance between the first housing member and the fan; and
an air discharging channel is formed among the first flexible portion, the second flexible portion, the first housing member and the fan; and, the air discharging channel is communicated with an air outlet of the fan.

19. The dust collection pile according to claim 18, wherein the fan assembly further comprises an air discharging hole, and the air discharging hole is communicated with the air discharging channel.

20. The dust collection pile according to claim 18, wherein the fan assembly further comprises a silencer, the silencer is provided on the housing, and one of an inlet of the silencer and an outlet of the silencer is communicated with the air discharging hole.

21. (canceled)

22. The dust collection pile according to claim 18, wherein the air discharging channel is provided around a circumferential outer surface of the fan, and a length of the air discharging channel extending along the circumferential outer surface of the fan is greater than a length of the air discharging hole extending along the circumferential outer surface of the fan.

23. A cleaning system comprising a dust collection pile, the dust collection pile comprising:
a body, comprising a dust inlet channel, the dust inlet channel having a dust inlet connected to a dust box;
a dust barrel, detachably provided on the body, a dust inlet end of the dust barrel being communicated with the dust inlet channel to collect dust entering through the dust inlet channel; and
a fan assembly, provided on the body, an air inlet of the fan assembly being communicated with an airflow outlet end of the dust barrel, and the fan assembly running and generating a negative pressure, such that the dust within the dust box is able to enter the dust inlet channel through the dust inlet and an airflow is enabled to circulate; wherein, the fan assembly comprises:
a housing;
a fan; and
a flexible member, located between two ends of the fan and the housing, the fan being fixed within the housing by the flexible member, and the flexible member being configured to avoid a direct contact between the fan and the housing.
